(19) United States
(12) Patent Application Publication
(10) Pub. No.: US 2009/0034555 A1
(43) Pub. Date: Feb. 5, 2009

(54) APPARATUS AND ASSOCIATED METHODOLOGY OF DETERMINING A TRANSMISSION TIME PER UNIT OF A FLOW OF DATA PACKETS

(75) Inventors: Pierre Boyer, Ile Grande (FR); Jacqueline Boyer, Ile Grande (FR)

Correspondence Address: OBLON, SPIVAK, MCCLELLAND MAIER & NEUSTADT, P.C., 1940 DUKE STREET, ALEXANDRIA, VA, 22314, US

(73) Assignee: FRANCE TELECOM, Paris (FR)

(21) Appl. No.: 12/181,054

(22) Filed: Jul. 28, 2008

(30) Foreign Application Priority Data
Jul. 27, 2007 (FR) 0756784

(51) Int. Cl. H04L 29/08

(52) U.S. Cl. 370/470

(57) ABSTRACT

An apparatus and associated methodology are provided for determining a transmission time per unit cell of a flow of data packets. A packet comprises at least one unit cell and the data packets are received in bursts. An expiration time is determined, beyond which a received data packet does not belong to a burst currently being observed, from a transmission time per unit cell.

If a received data packet belongs to the burst currently being observed, a transmission time per unit cell is re-estimated from the lengths of the data packets of the burst currently being observed,

The determining and re-estimating are repeated as long as data packets belonging to the burst currently being observed are received.

The advancements described herein relate to determining a transmission time per unit cell of a flow of data packets, an exemplary packet comprising at least one basic cell, the data packets being received in bursts at an observation point.

### BACKGROUND

The context here is the field of the observation of packet-switched communication networks and, more specifically, of the traffic circulating on the links of a communication network.

A link of such a communication network transports at least one data flow. The link can, for example, be an optical or copper Ethernet link. The transported data flows are generally multiplexed on this link asynchronously. Because of the multiplexing and the routing of the flows in the network by equipment implementing queues, they can arrive at an observation point in the form of bursts of data packets, alternating with periods of silence. The length of a packet is expressed as a function of the number of unit cells that it comprises, for example as a function of the number of octets. The cell might be the packet itself, for example an ATM cell. The data packets are of fixed or variable length.

One known method for measuring in real time the rate of a flow of packets is to count the number of unit cells of the data packets of the flow being observed over the duration of an observation window, possibly a sliding window. The expression “measuring in real time” should be understood to be a measurement that does not require a prior capture of a large quantity of data packets in a memory area, unlike an offline measurement which uses such a memory area to perform an offline analysis. Thus, a real-time method makes it possible to provide gradually a measurement, that is, a measurement as soon as possible after the arrival of each packet. The known method using a sliding observation window provides a way of obtaining an estimation of the rate that is relatively satisfactory, notably in a busy period. However, because of the temporal structure of the flow being observed, alternating bursts of data packets and periods of silence, the estimations of the rate are not accurate. Indeed, if too small a window size is chosen, the measurement is not very accurate because the count is made over too few data packets. However, if too large a window size is chosen, the periods of silence make the measurement less accurate.

It will be noted that measuring the rate of a flow is equivalent to measuring the time that elapses between two unit cells of the flow, this time being called hereinafter transmission time per unit cell.

There is therefore a need for a technique that makes it possible to reliably measure in real time the rate of a flow of data packets, the data packets of the data flow possibly being received in bursts.

### SUMMARY

The invention satisfies this need by proposing a method of determining a transmission time per unit cell of a flow of data packets, a packet comprising at least one unit cell, the data packets being received in bursts, said method comprising, for a burst currently being observed:

a—a step for determining an expiration time, beyond which a received data packet does not belong to said burst currently being observed, from a transmission time per unit cell;
b—if a received data packet belongs to the burst currently being observed, a step for re-estimating the transmission time per unit cell from the lengths of the data packets of the burst currently being observed,
the steps a and b being repeated as long as data packets belonging to the burst currently being observed are received.

Bursts of packets of a flow being observed are received in succession over a link of a communication network. The communication network can be any packet-switched communication network, for example an ATM, IP or Ethernet network. The expression “data packets” should be understood to mean a protocol data unit (PDU) for a layer of the OSI reference model, that is, a basic data packet exchanged between two devices by means of appropriate protocols, at the level of just one of the layers of the OSI model. As an example, it can concern ATM cells, packets or IP datagrams, Ethernet frames, etc.

The term “flow” should be understood to mean a flow relating to an ATM connection, an IP data flow, an aggregation of data of an application or data conveyed according to a predetermined protocol, etc. By defining a delimiting expiration time beyond which a received packet does not belong to the current burst, it thus becomes possible to identify distinct bursts in the succession of received packets.

For each packet belonging to the burst, a transmission time per unit cell can be estimated. The latter is then used to calculate the next delimiting expiration time, which is compared to the time of arrival of the next packet to decide if it belongs to the burst currently being observed. When determining the delimiting expiration time of the burst applicable to a given packet, the size of the packets of the burst constructed up until now is taken into account. It should be noted that implementing the method does not depend on the clocks of the underlying layers, given that the packets are time-stamped locally: the times of arrival of the packets are compared to a delimiting expiration time which is determined locally. The method is repeated as long as the received packets belong to the same burst.

At the end of an iteration, a transmission time per unit cell is obtained that takes account of all the packets of the burst constructed up until now. Thus, the size of an observation window is adapted optimally to each burst. The transmission time per unit cell determined in this way is reliable and accurate and is not affected by any periods of silence associated with transmission in bursts of packets.

It should also be noted that the method is applicable equally to data packets of fixed size and to data packets of variable size.

It is also applicable to a plurality of flows transmitted over one and the same link of the communication network.

It is particularly suitable for the subsequent control of an aggregation of IP flows conveyed, for example, by TCP (Transmission Control Protocol), so as to contain the Internet traffic in a routing capacity limited within a transmission line of the communication network.

Furthermore, the transmission time per unit cell is re-estimated according to a predetermined jitter tolerance, in order to guarantee a conformity of each data packet of the burst currently being observed with said transmission time constrained by said tolerance.

In this case, a jitter tolerance is set, that is, a time dispersion value that is admissible for a time of arrival of a packet. The jitter tolerance covers the propagation time variations due to the multiplexing of the flows. For a flow being observed, the aim is to guarantee a conformity of each data packet of the burst currently being observed to the transmission time per unit cell constrained by this tolerance. A packet is said to conform constrained by the tolerance if, when it is received before a conformity expiration time, the difference between the time of arrival and this expiration time is less than the tolerance value.

A transmission time is then determined that aims to guarantee the conformity of each of the received data packets forming the burst. At the earliest, a packet must be received within the conformity expiration time reduced by the jitter tolerance to be compliant. The transmission time per unit cell is then calculated to obtain the conformity of the received packet of the burst currently being observed.

In a first embodiment, the size of the packet received on an iteration is not used to determine the conformity expiration time that it must satisfy. The conformity of the packet is said to be a priori or called preconformity.

In a second embodiment, the size of the packet received on an iteration is used to determine the conformity expiration time that it must satisfy. The conformity of the packet is said to be a posteriori or post-conformity.

With these various determined indications, it is then possible to accurately define a provisioning of the links needed to carry the traffic. It is thus possible to estimate the resources needed to correctly carry the flows in terms of queue capacities and bandwidth. Furthermore, in the re-estimation step, a current transmission time per unit cell is determined. The method then comprises a test step, in which the smallest out of all the current transmission times per unit cell determined respectively on one iteration is retained as the transmission time per unit cell.

On an iteration, a current transmission time per unit cell is determined. If, for the next iteration, the smallest out of all the current transmission times per unit cell determined during the preceding iterations is retained as the transmission time per unit cell, there is a guarantee that each of the data packets forming the burst received on the preceding iterations conforms to the transmission time per unit cell constrained by the tolerance.

Furthermore, when a received data packet arrives beyond the expiration time, the observation of a new burst is begun.

When the data packet is received beyond the delimiting expiration time, it does not belong to the burst currently being observed. The observation of a new burst is then begun.

Furthermore, the method also comprises a backup step, in which the transmission time per unit cell of the burst previously being observed is stored and the smallest out of all the stored transmission times per unit cell is determined, so obtaining a transmission time per unit cell of the flow, making it possible to guarantee the conformity of each packet of the flow.

When the end of the burst is detected, the transmission time per unit cell determined on the last iteration becomes a transmission time per unit cell of this burst. This transmission time per unit cell of this burst guarantees the conformity to this transmission time constrained by the tolerance of each of the data packets of the burst. By retaining the lowest value of all the transmission times per unit cell of each burst, a transmission time per unit cell of the flow is obtained, which guarantees the conformity to this transmission time constrained by the tolerance of each of the packets of the flow.

In the first embodiment, the current transmission time per unit cell, at an iteration k greater than or equal to one, for a burst i currently being observed, is re-estimated using the following formula:

$${T}_{k}^{i} = \frac{{t}_{k} - {t}_{0} + τ}{{\sum }_{m = 0}^{k - 1} {S}_{m}}$$

where t₀ is the time of arrival of the first data packet of the burst, tₖ is the time of arrival of the data packet belonging to the burst, Sₘ the size of a packet of the burst and τ the jitter tolerance.

In the second embodiment, the current transmission time per unit cell, at an iteration k greater than or equal to one, for a burst i currently being observed, is re-estimated using the following formula:

$${T}_{k}^{i} = \frac{{t}_{k} - {t}_{0} + τ}{{\sum }_{m = 1}^{k} {S}_{m}}$$

where t₀ is the time of arrival of the first data packet of the burst, tₖ is the time of arrival of the data packet belonging to the burst, Sₘ the size of a packet of the burst and τ the jitter tolerance.

As a variant to this second embodiment, it is also possible to take into account the size of the first data packet and, in this case, the current transmission time per unit cell, at an iteration k greater than or equal to one, for a burst i currently being observed, is re-estimated using the following formula:

$${T}_{k}^{i} = \frac{{t}_{k} - {t}_{0} + τ}{{\sum }_{m = 0}^{k - 1} {S}_{m}}$$

The invention also relates to a device for determining a transmission time per unit cell of a flow of data packets, a packet comprising at least one unit cell, the data packets being received in bursts, said device comprising:
means of determining an expiration time, beyond which a received data packet does not belong to a burst currently being observed, arranged to determine an expiration time from a transmission time per unit cell;
means of re-estimating the transmission time per unit cell, for a burst currently being observed, from the lengths of the data packets of said burst;
control means, arranged to iteratively control the modules for determining an expiration time and for re-estimating the transmission time and as long as data packets belonging to the burst currently being observed are received.

The device can be a passive probe, tap-connected to a physical transmission link of the communication network. The device can also be an element of the communication network, such as a switch or a router.

The invention also relates to:
a program for a device for determining a transmission time per unit cell of a flow of data packets, comprising program code instructions for controlling the execution of the steps of the method described previously, when said program is executed by said device;
a storage medium that can be read by a device for determining a transmission time per unit cell, on which the program for a determination device is stored.

### BRIEF DESCRIPTION OF THE SEVERAL VIEWS OF THE DRAWINGS

The invention will be better understood from the following description of a particular embodiment of the inventive method, with reference to the appended drawings in which:

FIG. 1 is high a level block diagram of a device for determining a transmission time per unit cell of a flow of data packets, according to an exemplary embodiment of the invention;

FIG. 2 is a flowchart of the method for determining a transmission time per unit cell of a flow of data packets, according to a particular embodiment of the invention; and

FIG. 3 is a block diagram of a device for determining a transmission time per unit cell of a flow according to an exemplary embodiment of the invention.

### DETAILED DESCRIPTION

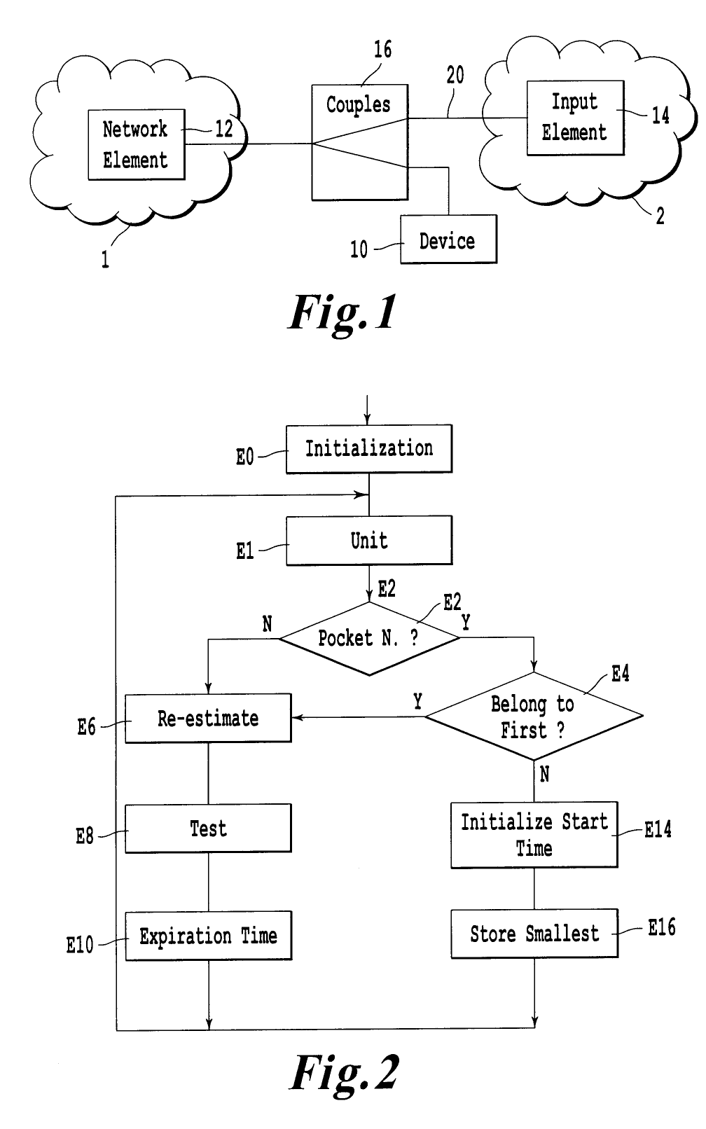

FIG. 1 represents a device 10 for determining a transmission time per unit cell of a flow of data packets, in its environment in a particular embodiment. Bursts of packets of the flow being observed are received in succession over a link 20 of a communication network. The communication network can be any packet-switched communication network, for example an ATM, IP or Ethernet network.

A link of the communication network transports at least one data flow. The transported data flows are multiplexed on this link, normally asynchronously. The link 20 of the communication network on which the observation is to be conducted links two equipments of communication networks 1, 2. The first communication network 1 corresponds, for example, to the network in which a video streaming source is located. The second communication network 2 is, for example, an IP network. The data flows are copied to the determination device 10 via a flow copying device, for example an optical coupler 16.

Also represented in FIG. 1 is a first element 12 of the communication network 1, for example an IP router, via which the flows output from the video streaming source are routed, and an input element 14 in the communication network 2.

In another embodiment, the device 10 for determining a transmission time per unit cell can be incorporated in an element of a communication network, for example one of the routers of the first communication network 1 or one of the routers of the second communication network 2.

Moreover, such a device 10 for determining a transmission time per unit cell of a flow of data packets can also be incorporated in an entity for setting the conformity of at least one flow.

The expression “data packets” should be understood to mean a protocol data unit (PDU) for a layer of the OSI reference model, that is, a basic data packet exchanged between two devices by means of appropriate protocols, at the level of just one of the layers of the OSI model. As an example, it can relate to ATM cells, IP packets or datagrams, Ethernet frames, etc. The term “flow” should be understood to mean a flow relating to an ATM connection, a flow of IP data, an aggregation of data from an application or of data conveyed according to a determined protocol, and so on.

The length of a data packet is expressed as a function of the number of unit cells that it comprises, for example as a function of the number of octets. The cell can, if appropriate, be the packet itself, for example an ATM cell. The data packets are of fixed or variable length.

A jitter tolerance is also defined. The jitter tolerance corresponds to a time dispersion value that is admissible for a time of arrival of a packet. The jitter tolerance covers the propagation time variations due to the multiplexing of the flows. As an example, for a real-time flow, such as a video stream, the jitter tolerance must be of the order of the transmission time of a few data frames, or for a flow encoded according to the MPEG-II standard in single-definition mode, of the order of 30 milliseconds. The jitter tolerance takes values greater than or equal to zero.

A packet is said to conform to a predetermined rate constrained by the jitter tolerance if, when it is received before a conformity expiration time for ensuring a rate less than or equal to the predetermined rate, the difference between the time of arrival and the expiration time is less than the tolerance value τ.

It should be noted that determining the elapsed time between two unit cells of the stream is equivalent to determining the rate of a flow, since these two quantities are the inverse of each other by expressing the rate as a number of unit cells per unit of time. The time between two unit cells is hereinafter called transmission time per unit cell.

Hereinafter, the expressions “conforming to a predetermined rate constrained by the tolerance” and “conforming to the predetermined transmission time constrained by the tolerance” are used interchangeably.

There now follows a description of the method of determining a transmission time per unit cell, in a first embodiment, in relation to FIG. 2.

In an initialization step E0, a first data packet is received and the start time of the burst t₀ is initialized to the time of arrival of this first data packet and the transmission time per unit cell of the burst and of the flow to a maximum value.

In this first embodiment, a so-called preconformity mode applies, that is, the size of the packet is not taken into account during the calculation of its conformity expiration time.

The first received data packet is then the first packet of the burst currently being observed, i.e. the packet P₀.

In a waiting step E1, the method awaits reception of a data packet.

If a data packet is received, the method switches to a test step E2.

In a test step E2, the method checks whether the received data packet is the second packet of the burst currently being observed. In practice, the first and second packets always belong to the burst currently being observed. If this received packet is the second packet of the burst, the method then switches to a step E6 for re-estimating the current transmission time per unit cell.

If it is not, that is, if the received data packet is not the second packet of the burst currently being observed, the method switches to a step E4 for testing whether the packet belongs to the burst currently being observed.

In the step E4 for testing whether the packet belongs to the burst currently being observed, a check is carried out to see if the time of arrival tₖ of the received data packet is less than a delimiting expiration time TATₖ. The delimiting expiration time used on this iteration is determined in a step E10 for determining the expiration time of the preceding iteration. If the time of arrival tₖ of the received data packet is less than the delimiting expiration time TATₖ, the data packet belongs to the burst currently being observed and the method switches to the step E6 for re-estimating the current transmission time per unit cell.

It should be noted hereinafter that, in this step of the method, the burst i currently being observed comprises data packets P₀ to Pₖ of respective lengths S₀ to Sₖ and respective reception times t₀ to tₖ. The lengths of the packets are obtained either by reading the packet header or by counting.

In the re-estimation step E6, the current transmission time per unit cell Tₖ is re-estimated from the lengths of the data packets of the burst currently being observed. This step E6 is detailed subsequently.

In a test step E8, the smallest out of all the current transmission times per unit cell is retained as the transmission time per unit cell for this burst i currently being observed, each of the current transmission times per unit cell being determined on an iteration of the method on this burst:

Tⁱ=min(Tⁱ,Tₖⁱ)

In practice, if, for the next iteration, the smallest out of all the current transmission times per unit cell is retained, it is guaranteed that each of the data packets received on the preceding iterations and comprising the burst currently being observed conforms to this transmission time per unit cell constrained by the tolerance.

In a step E10 for determining a delimiting expiration time, that is, an expiration time beyond which a received data packet does not belong to said burst currently being observed, the delimiting expiration time TATₖ₊₁ of the next packet Pₖ₊₁ is determined from the transmission time per unit cell Tⁱ and the length of the received data packets belonging to the burst i currently being observed:

$${TAT}_{k + 1} = {t}_{0} + {\sum }_{m = 0}^{k} {S}_{m} \cdot {T}^{i}$$

Once the delimiting expiration time has been determined in this way, namely the expiration time beyond which the next packet received does not belong to the burst i currently being observed, the method then switches to the step E1 of awaiting reception of a data packet.

The way in which the current transmission time per unit cell is re-estimated in the step E6 will now be described.

The theoretical time of arrival θₖ, also called conformity expiration time, of the data packet Pₖ is determined as follows:

$${θ}_{k} = {t}_{0} + {\sum }_{m = 0}^{k - 1} {S}_{m} \cdot {T}_{k}^{i}$$

An effort is made to determine the greatest possible current transmission time Tₖⁱ per unit cell given the tolerance τ allowed and the imposed constraint that each packet should conform. The greatest possible value of Tₖⁱ is obtained when the packet Pₖ, which arrives at the time tₖ, arrives at the earliest possible time before its theoretical time of arrival θₖ, that is:

$${t}_{k} = {θ}_{k} - τ = {t}_{0} - τ + {\sum }_{m = 0}^{k - 1} {S}_{m} \cdot {T}_{k}^{i}$$

Hence, the current transmission time per unit cell Tₖⁱ is determined as follows:

$${T}_{k}^{i} = \frac{{t}_{k} - {t}_{0} + τ}{{\sum }_{m = 0}^{k - 1} {S}_{m}}$$

Thus, the current transmission time per unit cell Tₖⁱ is re-estimated as a function of a predetermined jitter tolerance τ, in order to guarantee a conformity of the data packet Pₖ of the burst i currently being observed to said transmission time constrained by said tolerance.

The case in which, in the step E4 for testing whether the packet belongs to the burst currently being observed, it has been determined that the received data packet does not belong to the burst i currently being observed now applies. The received data packet therefore delimits a new burst (i+1) for which observation begins. In a step E14, the start time t₀ of this new burst is initialized to the time of arrival of this data packet and the transmission time per unit cell of the burst to a maximum value. It should be noted that the implementation of the method does not depend on the clocks of the underlying layers, given that the time-stamping is performed locally: in practice, the times of arrival of the packets are compared to a delimiting expiration time which is itself determined locally.

In a backup step E16 corresponding to the processing of the data obtained from the observation of the burst i, for which the observation is finished, the transmission time per unit cell Tⁱ of the burst i is stored.

Thus, the size of an observation window is adapted optimally to each burst. The transmission time per unit cell of the burst determined in this way is reliable and accurate and is not affected by any periods of silence associated with the transmission of packets in bursts.

In this step E16, the smallest out of all the transmission times per unit cell of the various bursts observed is also stored. By retaining the most reliable value of all the transmission times per unit cell of the various bursts observed, a transmission time per unit cell of the flow is obtained which guarantees the conformity of each of the packets of the flow to this transmission time constrained by the tolerance.

Optionally, in the step E16, a smoothed transmission time R per unit cell of the flow is determined by applying a linear filter to the transmission time values per unit cell of each stored observed burst. This smoothed transmission time per unit cell of the flow is then determined as follows, Rⁱ designating the value of R at the end of the burst i:

Rⁱ=Rⁱ⁻¹(1−p)+pTⁱ

p can, for example, be chosen to be equal to 1/1024.

By applying a linear filter to the transmission time values per unit cell obtained for each burst, a smoothed value is obtained which does not guarantee the conformity of each packet of the flow to the rate corresponding to this transmission time R together with the tolerance but which allows for a less exacting allocation of resources.

In a second embodiment, a so-called post-conformity mode applies, that is, one in which the size of the current data packet is taken into account in the calculation of the conformity expiration time.

This embodiment differs from the preceding one in the way in which the current transmission time per unit cell is re-estimated in the re-estimation step E6.

In this second embodiment, in the re-estimation step E6, the current transmission time per unit cell Tₖⁱ is re-estimated from the lengths of the data packets of the burst currently being observed.

The theoretical time of arrival θₖ, also called conformity expiration time, of the data packet Pₖ is determined as follows:

$${θ}_{k} = {t}_{0} + {\sum }_{m = 1}^{k} {S}_{m} \cdot {T}_{k}^{i}$$

To determine the greatest possible transmission time Tₖⁱ per unit cell given the tolerance τ allowed and the imposed constraint that each packet should conform is sought. The greatest possible value of Tₖⁱ is obtained when the packet Pₖ, which arrives at the time tₖ, arrives at the earliest possible time before its theoretical time of arrival θₖ, that is:

$${t}_{k} = {θ}_{k} - τ = {t}_{0} - τ + {\sum }_{m = 1}^{k} {S}_{m} \cdot {T}_{k}^{i}$$

Hence, the transmission time per unit cell Tₖⁱ is determined as follows:

$${T}_{k}^{i} = \frac{{t}_{k} - {t}_{0} + τ}{{\sum }_{m = 1}^{k} {S}_{m}}$$

Thus, the current transmission time per unit cell Tₖⁱ is re-estimated as a function of a predetermined jitter tolerance τ, in order to guarantee a conformity of the data packet Pₖ of the burst i currently being observed to said transmission time constrained by said tolerance.

As a variant to this second embodiment, the size S₀ of the first received packet belonging to the burst currently being observed is taken into account in the calculation of the conformity expiration time. The following equation is then obtained for re-estimating the current transmission time per unit cell on the iteration k, in the step E6 for re-estimating the current transmission time per unit cell:

$${T}_{k}^{i} = \frac{{t}_{k} - {t}_{0} + τ}{{\sum }_{m = 0}^{k} {S}_{m}}$$

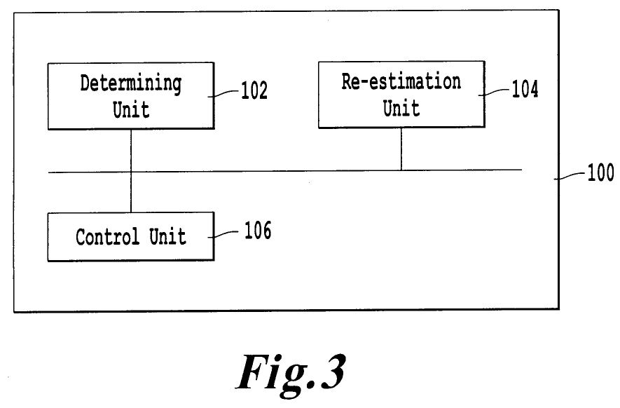

There now follows a description of a device 100 for determining a transmission time per unit cell of a flow of data packets, a packet comprising at least one unit cell, the data packets being received in bursts, in relation to FIG. 3.

The device 100 comprises:
a module 102 for determining a delimiting expiration time, beyond which a received data packet does not belong to a burst currently being observed, arranged to determine a delimiting expiration time from a transmission time per unit cell;
a module 104 for re-estimating the transmission time per unit cell, for a burst currently being observed and for a received data packet belonging to the burst currently being observed, from the lengths of the data packets of said burst;
a control module 106, arranged to iteratively control the modules for determining a delimiting expiration time 102 and for re-estimating the transmission time per unit cell 104 and as long as data packets belonging to the burst currently being observed are received.

The re-estimation module 104 is also arranged to re-estimate the transmission time per unit cell also as a function of a predetermined jitter tolerance, in order to guarantee a conformity of each data packet of the burst currently being observed to this transmission time constrained by the tolerance.

Optionally, the module 104 for re-estimating the transmission time per unit cell is also arranged to determine a current transmission time per unit cell and to retain the smallest out of all the current transmission times per unit cell respectively determined on an iteration as the transmission time per unit cell.

The control module 106 is also arranged to initialize the observation of a new burst and to determine the smallest out of all the transmission times per unit cell of each stored burst, so obtaining a transmission time per unit cell of the flow, making it possible to guarantee the conformity of each packet of the flow.

The modules 102, 104 and 106 are arranged to implement the method described previously. They are preferably software modules comprising software instructions for the execution of the steps of the method described previously, implemented by the determination device. The invention therefore also relates to:
a program for a device for determining a transmission time per unit cell of a flow of data packets, comprising program code instructions for controlling the execution of the steps of the method described previously, when said program is executed by said device;
a storage medium that can be read by a device for determining a transmission time per unit cell, on which the program for a determination device is stored.

The software modules can be stored in or transmitted by a data medium. This can be a physical storage medium, for example a CD-ROM, a magnetic diskette or a hard disk, or even a transmission medium such as an electrical, optical or radio signal, or a telecommunication network.

It should also be noted that the method is applicable equally to data packets of fixed size and to data packets of variable size.

It is also applicable to a plurality of flows transmitted over one and the same link of the communication network.

It is particularly usable for the subsequent control of an aggregation of IP flows conveyed, for example, by TCP (Transmission Control Protocol), so as to contain the Internet traffic in a routing capacity limited within a transmission line of the communication network.

1. A method of determining a transmission time per unit of a flow of data packets, a packet of the flow of data packets including at least one unit cell, the data packets being received in bursts, comprising:
determining an expiration time, beyond which a received data packet does not belong to a burst currently being observed, from a transmission time per unit cell;
re-estimating the transmission time per unit cell from the lengths of the data packets of the burst currently being observed if a received data packet belongs to the burst currently being observed,
repeating the determining and re-estimating as long as data packets belonging to the burst currently being observed are received.

2. The method according to claim 1, in which the transmission time per unit cell is re-estimated according to a predetermined jitter tolerance, in order to guarantee a conformity of each data packet of the burst currently being observed to said transmission time constrained by said tolerance.

3. The method according to claim 1, in which, in the re-estimation, a current transmission time per unit cell is determined, said method further comprising:
retaining the smallest out of all the current transmission times per unit cell determined respectively on one iteration, as the transmission time per unit cell.

4. The method according to claim 1, wherein, when a received data packet arrives beyond the expiration time, the observation of a new burst is begun.

5. The method according to claim 4, further comprising:
storing the transmission time per unit cell of the burst previously being observed, and the smallest out of all the stored transmission times per unit cell is determined, so obtaining a transmission time per unit cell of the flow, making it possible to guarantee the conformity of each packet of the flow.

6. The method according to claim 2, wherein the current transmission time per unit cell, at an iteration k greater than or equal to one, for a burst i currently being observed, is re-estimated using the following formula:
$${T}_{k}^{i} = \frac{{t}_{k} - {t}_{0} + τ}{{\sum }_{m = 0}^{k - 1} {S}_{m}}$$
where t₀ is the time of arrival of the first data packet of the burst, tₖ is the time of arrival of the data packet belonging to the burst, Sₘ the size of a packet of the burst and τ the jitter tolerance.

7. The method according to claim 2, wherein the current transmission time per unit cell, at the iteration k greater than or equal to one, for a burst i currently being observed, is re-estimated using the following formula:
$${T}_{k}^{i} = \frac{{t}_{k} - {t}_{0} + τ}{{\sum }_{m = 0}^{k} {S}_{m}}$$
where t₀ is the time of arrival of the first data packet of the burst, tₖ is the time of arrival of the data packet belonging to the burst, Sₘ the size of a packet of the burst and τ the jitter tolerance.

8. An apparatus for determining a transmission time per unit cell of a flow of data packets, a packet of the flow data packets including at least one unit cell, the data packets being received in bursts, comprising:
a determining unit configured to determine an expiration time, beyond which a received data packet does not belong to a burst currently being observed, arranged to determine an expiration time from a transmission time per unit cell;
a re-estimating unit configured to re-estimate the transmission time per unit cell, for a burst currently being observed, from the lengths of the data packets of said burst;
a controller configured to iteratively control the modules for determining an expiration time and for re-estimating the transmission time and as long as data packets belonging to the burst currently being observed are received.

9. A computer readable storage medium encoded with computer program instructions which cause a computer to execute a method of determining a transmission time per unit of a flow of data packets, a packet of the flow of data packets including at least one unit cell, and the data packets being received in bursts, comprising:
determining an expiration time, beyond which a received data packet does not belong to a burst currently being observed, from a transmission time per unit cell;
re-estimating the transmission time per unit cell from the lengths of the data packets of the burst currently being observed if a received data packet belongs to the burst currently being observed,
repeating the determining and re-estimating as long as data packets belonging to the burst currently being observed are received.
